(19) United States
(12) Patent Application Publication
(10) Pub. No.: US 2004/0192423 A1
(43) Pub. Date: Sep. 30, 2004

(54) Communication using electroshocks

(76) Inventor: Peter Nevermann, Dusseldorf (DE)

Correspondence Address: Siemens Corporation, Attn: Elsa Keller, Legal Administrator, Intellectual Property Department, 170 Wood Avenue South, Iselin, NJ, 08830, US

(21) Appl. No.: 10/396,934

(22) Filed: Mar. 24, 2003

(51) Int. Cl. H04B 1/38

(52) U.S. Cl. 455/575.6; 455/567; 455/550.1

(57) ABSTRACT

A mobile communication device employs electrical stimulation for silently alerting the user that information has been received by the mobile communication device. The mobile communication device includes an electrical power source for generating an electrical signal and an electrode assembly coupled to the electrical power source for communicating the electrical signal to the body of a user of the mobile communication device. The electrical signal provides an electrical stimulation to the body of the user when communicated to the body by the electrode assembly for silently alerting the user that information has been received by the communication device.

### BACKGROUND OF THE INVENTION

The present invention relates generally to mobile communication devices such as mobile telephones, pagers, wireless enabled palmtop computers, or the like, and more particularly, to a mobile communication device employing electrical stimulation for silently alerting its user that information such as a telephone call, a text message, a voice message, a page, or the like has been received by the communication device.

Mobile communication devices, in particular mobile telephones, pagers, and the like, often include a “silent alert” function which employs a vibrating mechanism to alert the user of the communication device that information such as a telephone call, a voice message, a text message, a page, or the like has been received. Such silent alert mechanisms are used in place of an audible ring at times when an audible ring would be deemed obtrusive or inappropriate (e.g., in a theatre, church, restaurant, or the like). However, vibrating silent alert mechanisms typically require a large amount of electrical power to operate. Consequently, these mechanisms, if used often, greatly reduce the service life of batteries used to power the mobile communication device. Moreover, typical vibrating silent alert mechanisms consist of a small electric motor that drives vibration elements, which in turn causes the housing of the mobile communication device to vibrate. As a result, such vibrating silent alert mechanisms are, by necessity, somewhat bulky, increasing the size of the mobile communication device in which they are employed. Accordingly, in applications where it is desirable that the mobile communication device have an extremely small volume (e.g., wristwatch mobile telephones, a mobile telephone designed to be worn as a necklace, or the like), a silent alert function often cannot be provided.

Consequently, it is desirable to provide a mobile communication device having a silent alert function for alerting the user that information has been received by the mobile communication device, which does not employ a mechanical vibrating mechanism for providing this function.

### SUMMARY OF THE INVENTION

The present invention is directed to a mobile communication device such as a mobile telephone, a pager, a wireless enabled palmtop computer, or the like, which employs electrical stimulation for silently alerting the user that information such as a telephone call, text message, voice message, page, or the like has been received by the mobile communication device.

According to a specific embodiment, the present invention provides a mobile communication device that comprises an electrical power source for generating an electrical signal and an electrode assembly coupled to the electrical power source for communicating the electrical signal to the body of a user of the communication device. The electrical signal provides an electrical stimulation to the body of the user when communicated to the body by the electrode assembly for silently alerting the user that information has been received by the mobile communication device. In exemplary embodiments, the mobile communication device may further include a controller for controlling communication of the electrical signal to the body of the user by controlling at least one of the voltage of the electrical signal, the current of the electrical signal, the amplitude of the electrical signal, frequency of the electrical signal, the point on the body where the electrical signal is applied, and the form of the electrical signal.

According to a second specific embodiment, the present invention provides a mobile communication device that comprises a housing and a band assembly coupled to the housing for attaching the housing to the user of the mobile communication device, e.g., in a manner similar to a conventional wristwatch. An electrical power source is provided within the housing for generating an electrical signal, which is communicated to the user of the mobile communication device via an electrode assembly coupled to the electrical power source. A controller controls communication of the electrical signal via the electrode assembly to provide an electrical stimulation to the user for silently alerting the user that information has been received by the mobile communication device.

According to a third specific embodiment, the present invention provides a mobile communication device that comprises a housing and a hanging assembly coupled to the housing for hanging the housing from a user of the mobile communication device. An electrical power source is provided within the housing for generating an electrical signal, which is communicated to the body of the user via an electrode assembly coupled to the electrical power source. A controller controls communication of the electrical signal to provide an electrical stimulation to the user for silently alerting the user that information has been received by the mobile communication device.

It is to be understood that both the foregoing general description and the following detailed description are exemplary and explanatory only and are not necessarily restrictive of the invention claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

FIGS. 1A and 1B are block diagrams illustrating a mobile communication device employing electrical stimulation to furnish a silent alert function for silently alerting its user that information has been received by the communication device in accordance with an exemplary embodiment of the present invention;

FIG. 2 is an isometric view illustrating a mobile communication device, specifically a mobile telephone configured to be worn about the wrist of a user in accordance with an exemplary embodiment of the present invention;

FIG. 3 is a side elevation view of the communication device shown in FIG. 2, further illustrating contact between the electrodes of the electrode assembly and the wrist of the wearer;

FIGS. 4 and 5 are bottom plan views of the mobile communication device shown in FIG. 2, further illustrating exemplary positioning of electrodes of the electrode assembly of the mobile communication device;

FIG. 6 is an isometric view illustrating a mobile communication device, specifically a mobile telephone configured to be worn as a necklace about the neck of a user in accordance with a second exemplary embodiment of the present invention;

FIGS. 7 and 8 are isometric views of the mobile communication device shown in FIG. 6, further illustrating exemplary positioning of electrodes of the electrode assembly of the mobile communication device;

FIG. 9 is an isometric view of the communication device shown in FIG. 6, further illustrating detachment of the necklace assembly from the housing of the mobile communication device;

FIGS. 10 and 11 are isometric views illustrating a mobile communication device, specifically a mobile telephone having a belt clip, in accordance with a third exemplary embodiment of the present invention; and

FIGS. 12 and 13 are rear elevation views of the mobile communication device shown in FIGS. 10 and 11, further illustrating exemplary positioning of electrodes of the communication device.

### DETAILED DESCRIPTION OF SPECIFIC EMBODIMENTS

Reference will now be made in detail to the presently preferred embodiments of the invention, examples of which are illustrated in the accompanying drawings.

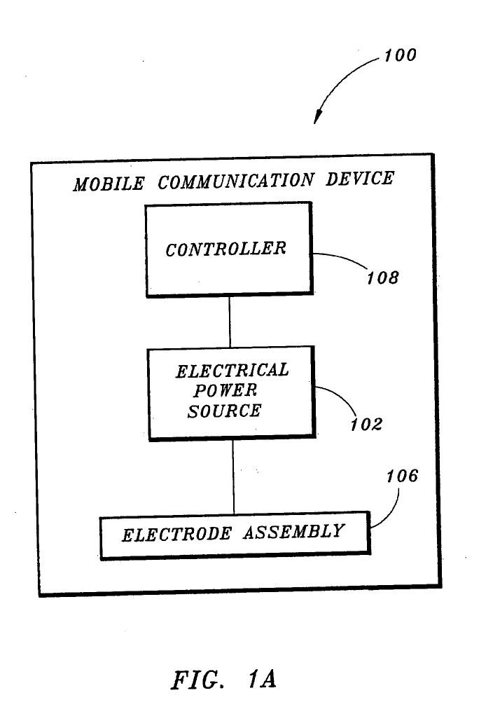

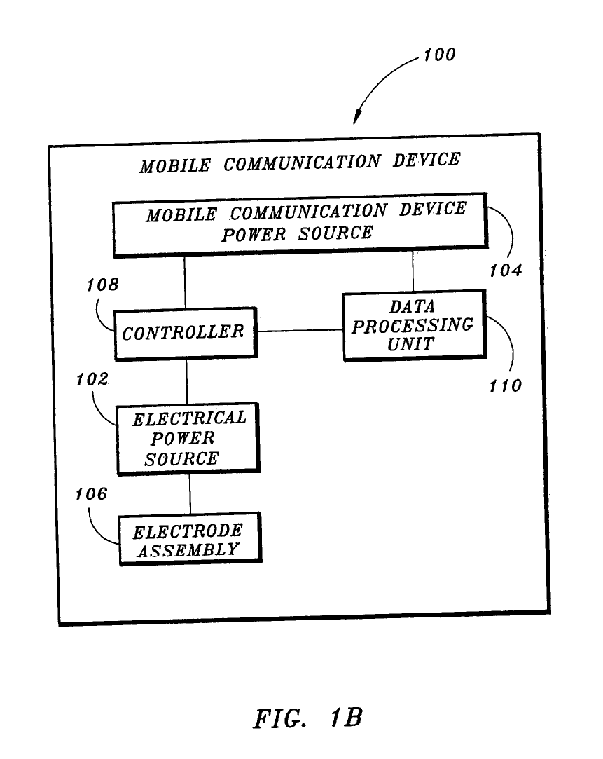

FIGS. 1A and 1B illustrate a mobile communication device 100 in accordance with an exemplary embodiment of the present invention. The mobile communication device 100 employs electrical stimulation via mild electroshocks applied to the body of a user of the communication device 100 for silently alerting the user that information such as a telephone call, a text message, a voice message, a page, a warning message, or the like, has been received by the communication device 100 from an external source. In this manner, electrical stimulation is used in place of mechanical vibration to provide a silent alert function for the mobile communication device 100. The mobile communication device 100 may also employ electrical stimulation to convey various other information, in particular, internally generated information including, for example, a low battery indication, an indication that the mobile communication device 100 is out of range of a cellular communication system tower or base station, an indication that the silent alert function has been switched on or off, or the like. In embodiments of the invention, the mobile communication device 100 may further vary the electrical stimulation communicated to the user to distinguish the type of information received or provided. Thus, for example, the mobile communication device 100 may communicate different electrical stimulations to its user to indicate that the mobile communication device 100 has received a telephone call, a text message or a voice mail message, or to indicate that the battery of the mobile communication device 100 is low, or that the mobile communication device 100 is out of range of a cellular communication system tower.

In the past, electrical stimulation of the body has been used primarily for therapeutic purposes in applications such as Transcutaneous Electrical Nerve Stimulation (TENS) and Electronic Muscle Stimulation (EMS). TENS units electrically stimulate sensory nerves to block pain signals, and to stimulate endorphin production to help normalize sympathetic function. EMS systems electrically stimulate motor nerves to cause a muscle contraction and are used to prevent or reduce muscle atrophy after surgeries or injuries. However, such devices utilize electrical stimulation over long periods of time and employ voltages and currents intended to effect therapeutic changes to the body, and not to communicate information to their users. In contrast, the present invention employs electrical stimulation comprising pulses of relatively short duration that are generally non-therapeutic, but which are non-harmful to the user.

As illustrated in FIGS. 1A and 1B, the mobile communication device 100 includes an electrical power source 102 for furnishing an electrical signal suitable for providing electrical stimulation to the body of a user of the mobile communication device 100. In exemplary embodiments of the invention, the electrical power source 102 comprises a controllable high voltage power source such as capacitor based electrical storage assembly, or the like, furnishing electrical signals having high voltages and low currents, preferably of alternating wave forms. As shown in FIG. 1B, the electrical power source 102 may draw power or be charged from a second electrical power source or storage device 104 within the mobile communication device 100. In exemplary embodiments, this second electrical power source 104 may comprise a battery providing power for the mobile communication device 100, or, alternatively, a charging system for charging the battery of the mobile communication device 100, a second battery dedicated to providing power to the electrical power source 102, or the like.

The electrical power source 102 is coupled to an electrode assembly 106 for communicating the electrical signal furnished by the electrical power source 102 to the body of the user. The electrode assembly 106 includes two or more electrodes furnished in the housing of the mobile communication device 100, or, alternatively, in a wristband, wrist strap, necklace, belt clip, or the like, coupled to the housing of the mobile communication device 100. In exemplary embodiments, these electrodes may be galvanically coupled to the body of the user (i.e., the conducting metal of the electrodes are placed in direct contact with the skin of the user). Alternatively, the electrodes may be capacitively coupled to the body of the user so that the electrical signal is passed through a thin insulator such as the clothing of the user.

In preferred embodiments, the mobile communication device 100 employs an electrical signal having a voltage and current selected to provide a distinguishable sensation to the user, but which is not uncomfortable or harmful to the user. For example, in one embodiment, the mobile communication device 100 employs an electrical signal comprising pulses of alternating high voltage/low current electricity. When communicated to the body, the electrical signal provides a brief, localized electrical stimulation to sensory nerves of the body near the electrodes of the electrode assembly 106.

A controller 108 is coupled to the electrical power source 102 for controlling communication of the electrical signal to the body of the user via the electrode assembly 106. As shown in FIG. 1B, the controller 108 may further regulate charging of the electrical power source 102 by the mobile communication device electrical power source 104. In exemplary embodiments, the controller 108 comprises a voltage/current control device for controlling the voltage and current of the electrical signal supplied to the electrode assembly 106 by the electrical power source 102. In one embodiment, the controller 108 further includes a switch or switching assembly for turning the electrical signal on and off to apply one or more discernable electrical pulses to the skin of the user. In other embodiments, the controller may comprise a processor based system for controlling characteristics of the electrical signal such as the voltage of the electrical signal, the current of the electrical signal, the amplitude of the electrical signal, the point on the body where the electrical signal is applied, the form or nature of the electrical signal (e.g., the length of the electrical signal, frequency of application of the electrical signal, etc.), or the like, to vary the electrical stimulation applied to the body of the user. Preferably, the user may select and assign distinct electrical stimulations to be associated with particular types of information received or provided by the mobile communication device 100. Alternatively, default electrical stimulations may also be assigned, for example, if user assignment is not provided. In this manner, the controller 108 may provide an electrical stimulation having a distinctive sensation for distinguishing the type of information received or provided by the mobile communication device 100.

As shown in FIG. 1B, the controller 108 may be coupled to a main data processing unit 110, which controls operation of the mobile communication device 100. When it is desirable that the user be silently notified that information has been received or generated by the mobile communication device 100 (e.g., the silent alert function of the mobile communication device is turned on and such information is received or generated), the data processing unit 110 commands the controller 108 to cause an electrical signal to be transmitted the electrode assembly 106. The data processing unit 110 may further command the controller 108 to cause a particular type of electrical signal to be provided (i.e., by varying characteristics of the electrical signal) to distinguish the type of information received or provided by the mobile communication device 100. For example, the data processing unit 110 may pass a command signal to the controller 108 instructing the controller 108 that a telephone call has been received by the mobile communication device 100. The controller 108 may then cause an electrical signal to be provided to the electrode assembly 106 by the electrical power source 102, for causing electrical stimulation to the body of the user having characteristics capable of communicating to the user that information has been received by the mobile communication device 100, and that the information received by the mobile communication device 100 is a telephone call.

The mobile communication device 100 may further include components suited for providing wireless communication of voice and/or data information with external sources such as a base station, a cellular communication system tower, a second mobile communication device, or the like. For example, in embodiments where the mobile communication device 100 comprises a mobile telephone, the mobile communication device 100 may comprise such components as a processing assembly (which may comprise data processing unit 110), memory, a transmitter/receiver assembly or transceiver, a microphone, a speaker, a data card reader for receiving a data card (e.g., SIN (subscriber identification module) card, a user identification module (UIM) card, or the like), an antenna, a display, a keypad, control buttons, or the like. Further, it will be appreciated that the mobile communication device 100 may provide functions other than communication. For example, the mobile communication device 100 may provide functions common to hand held computers or personal digital assistants (PDAs). In such embodiments, the mobile communication device may further include a suitable processing system, extended memory, a digitizer screen or touch screen, or the like.

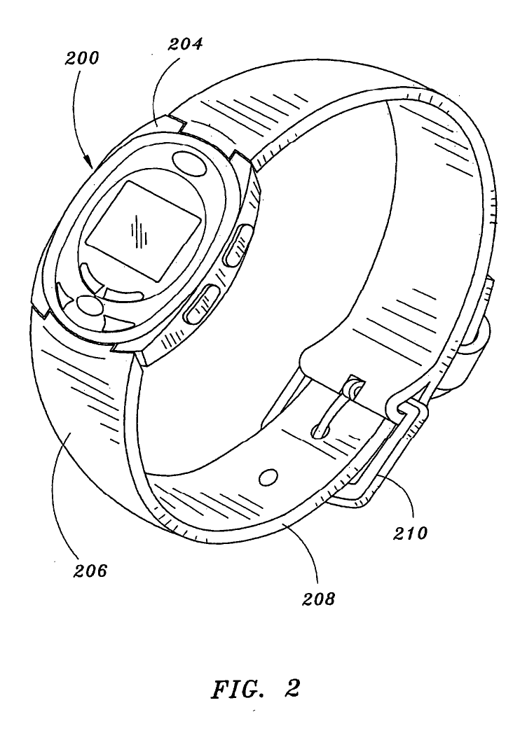

FIGS. 2 through 5 illustrate an exemplary mobile communication device 200 in accordance with the present invention, which comprises a mobile telephone configured to be worn on the wrist 202 of a user in a manner similar to a conventional wristwatch. In this embodiment, the mobile communication device 200 includes a housing 204 containing an electrical power source 102 and controller 108 as discussed in the description of FIGS. 1A and 1B. A wristband assembly 206 is coupled to the housing 204 for securing the housing 204 to the wrist 202 of the user. In FIGS. 2 through 5, a wristband assembly 206 comprised of a two-piece strap 208 and buckle 210 is illustrated. However, it will be appreciated by those of ordinary skill in the art that, depending on design preferences, the mobile communication device 200 may alternatively employ other types of wristband assemblies 206 (e.g., a flexible bracelet, a bracelet having a fold over clasp, or the like) without departing from the scope and intent of the present invention.

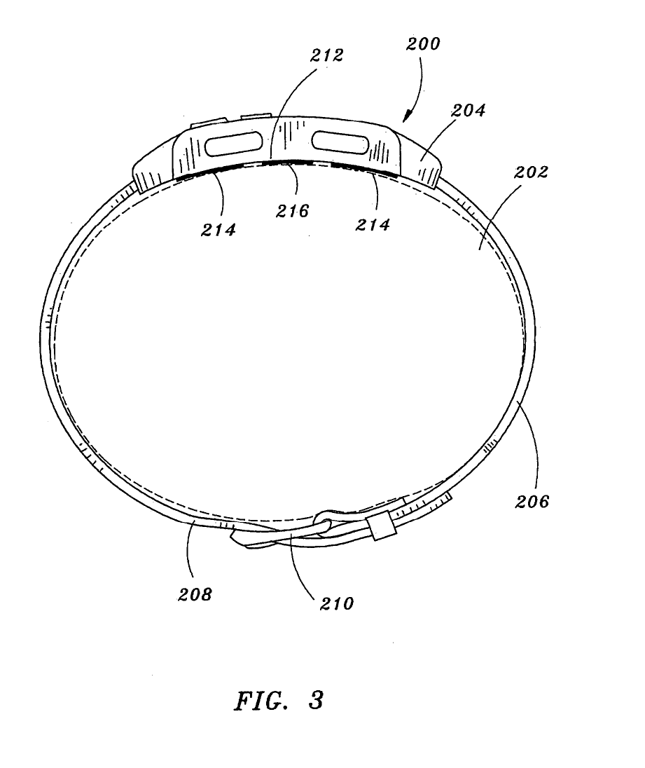

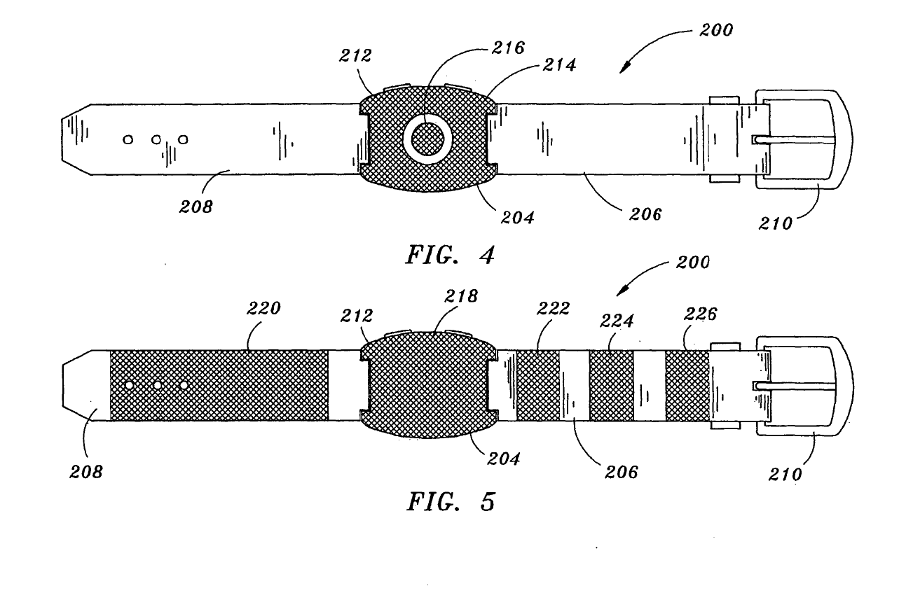

In one embodiment, the mobile communication device 200 includes an electrode assembly 212 having electrodes disposed entirely within the housing 204 of the mobile communication device 200. For example, as shown in FIG. 3 and 4, the electrode assembly 212 may include a first electrode 214 and a second electrode 216 positioned on the inner surface of the housing 204 of so that the electrodes 214 and 216 are held in galvanic contact with the skin when the mobile communication device 200 is worn about the wrist 202 of the user. In this embodiment, one electrode 214 or 216 preferably functions as a positive electrode, while the other electrode 216 or 214 functions as a negative electrode. The electrical signal provided by the electrode assembly 212 is thus passed between the electrodes 214 and 216, through the body (i.e., along the back of the wrist 202) to stimulate sensory nerves within the skin of the wrist 202.

In other embodiments, the electrode assembly 212 may further include electrodes positioned in the wristband assembly 206 in addition to, or, alternatively, in place of the electrodes disposed on the housing 204. For example, in the embodiment shown in FIG. 5, the electrode assembly 212 includes a first electrode 218 positioned on the inner surface of the housing 204 of the mobile communication device 200. Additional electrodes 220, 222, 224 and 226 are provided on the inner surface of the wristband assembly 206. Preferably, one or more of the electrodes 218-226 function as positive electrodes, while other of the electrodes 218-226 function as negative electrodes. Thus, the electrical signal provided by the electrode assembly 212 is passed between two or more of the electrodes 218-226, through the body (i.e., along or through the wrist 202) to stimulate sensory nerves within the skin of the wrist 202. Preferably, the number and position of electrodes 218-226 that are excited (i.e., that are used to convey an electrical signal) is controlled (e.g., by controller 108 shown in FIGS. 1A and 1B) to vary the form of the electrical stimulation communicated to the user. In this manner, the electrode assembly 212 may provide electrical stimulations having characteristics that may be distinguished by the user and may be associated by the user with the type of information received or provided by the mobile communication device 200 (e.g., a telephone call, text message, low battery indication, or the like).

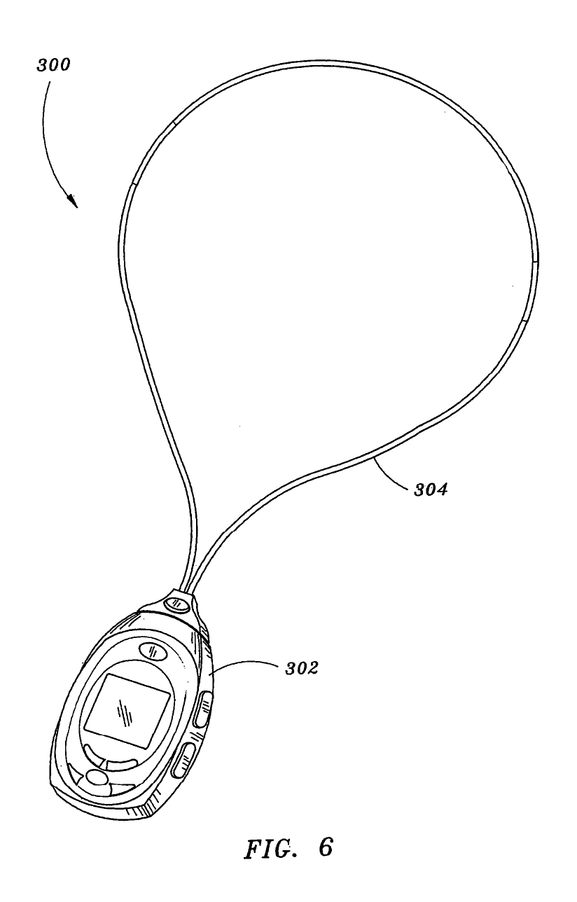

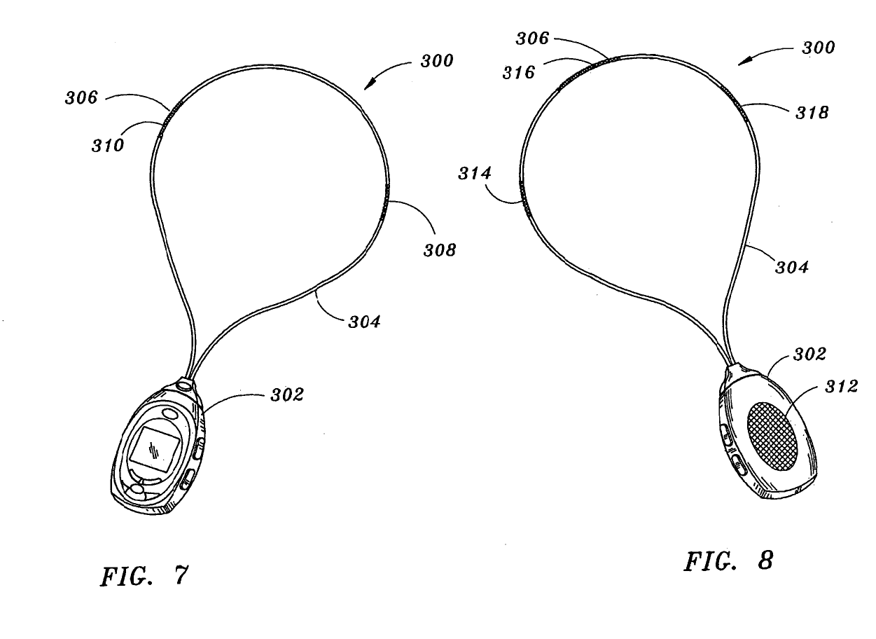

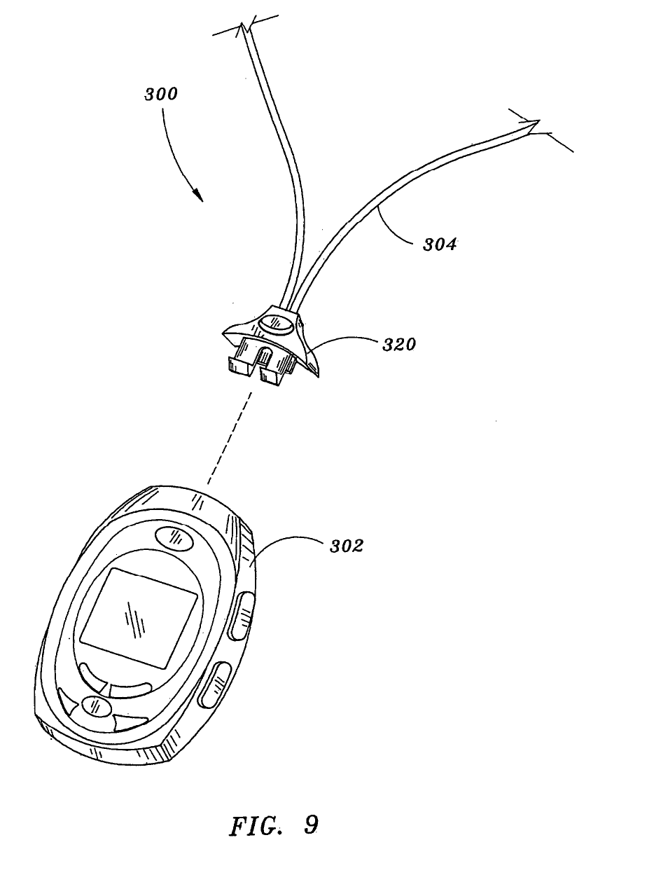

FIGS. 6 through 9 illustrate an exemplary mobile communication device 300, which comprises a mobile telephone configured to be worn, e.g., as a necklace about the neck of a user of the mobile communication device 300. In this embodiment, the mobile communication device 300 includes a housing 302 containing an electrical power source 102 and controller 108 as discussed in the description of FIGS. 1A and 1B. A necklace assembly 304 is coupled to the housing 302 for hanging the housing 302 about the neck of the user. The electrode assembly 306 of the mobile communication device 300 comprises electrodes 308 and 310 (FIG. 7) or 312-318 (FIG. 8) positioned within the necklace assembly 306 and/or the housing 302 of the mobile communication device 300 so that they are held in galvanic or capacitive contact with the skin of the user when the mobile communication device 300 is worn about the neck of the user. In exemplary embodiments, the necklace assembly 304 may be detached from the housing 302 when not needed. In such embodiments, a clasp 320 may be provided for attaching the necklace assembly 304 to the housing 302 of the mobile communication device 300. Preferably, the clasp 320 provides electrical interconnection of the necklace assembly 304 for transmitting the electrical signal to the electrodes (i.e., electrodes 308 and 310 (FIG. 7) or electrodes 314 318 (FIG. 8)) of the electrode assembly 306.

In one embodiment, shown in FIG. 7, the electrode assembly 306 may include a first electrode 308 and a second electrode 310 integrally formed in the necklace assembly 304 so that they are in galvanic contact with the neck of the user while the user wears the mobile communication device 300. In this embodiment, one electrode 308 or 310 functions as positive electrode, while the other electrode 310 or 308 functions as a negative electrode so that the electrical signal provided by the electrode assembly 306 is passed between the electrodes 308 and 310, through the body to stimulate sensory nerves within the skin of the user. Alternatively, the electrode assembly 306 may comprise three or more electrodes positioned about the necklace and/or one or more electrodes disposed in the housing 302 of the mobile communication device 300. For example, in the embodiment shown in FIG. 8, the electrode assembly 306 comprises a first electrode 312 positioned on the inner surface of the housing 302 of the mobile communication device 300 and three electrodes 314, 316 and 318 spaced about the necklace assembly 304. In this embodiment, one or more of the electrodes 312-316 function as positive electrodes, while the remaining electrodes 312-316 function as negative electrodes so that the electrical signal provided by the electrode assembly 306 is passed between two or more of the electrodes 312-316, through the body to stimulate sensory nerves within the skin. Preferably, the number and position of electrodes 312-316 that are excited is controlled (e.g., by controller 108 shown in FIGS. 1A and 1B) to vary the form of the electrical stimulation communicated to the user. In this manner, the electrode assembly 306 may provide electrical stimulations having characteristics that may be distinguished by the user and may be associated by the user with the type of information received or provided by the communication device 300 (e.g., a telephone call, text message, low battery indication, or the like).

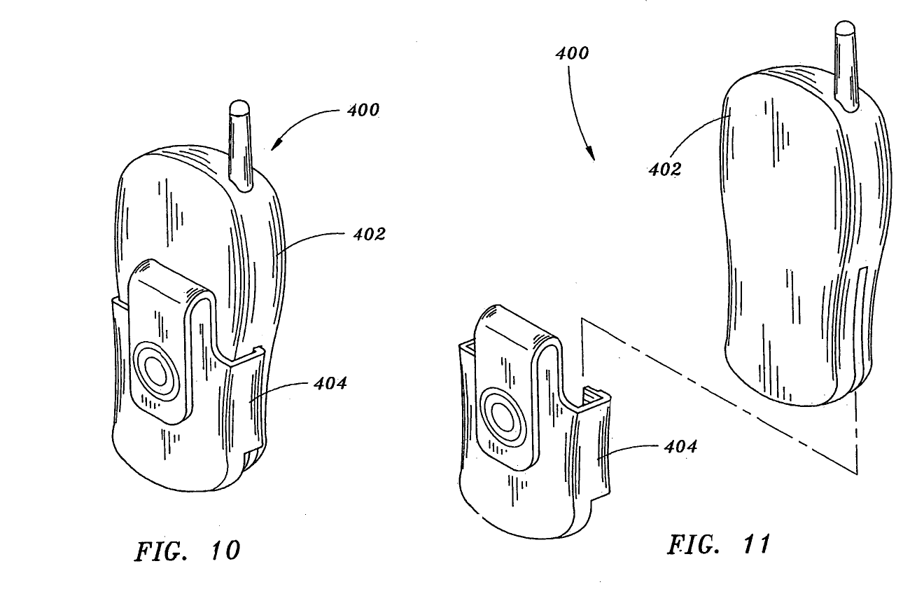

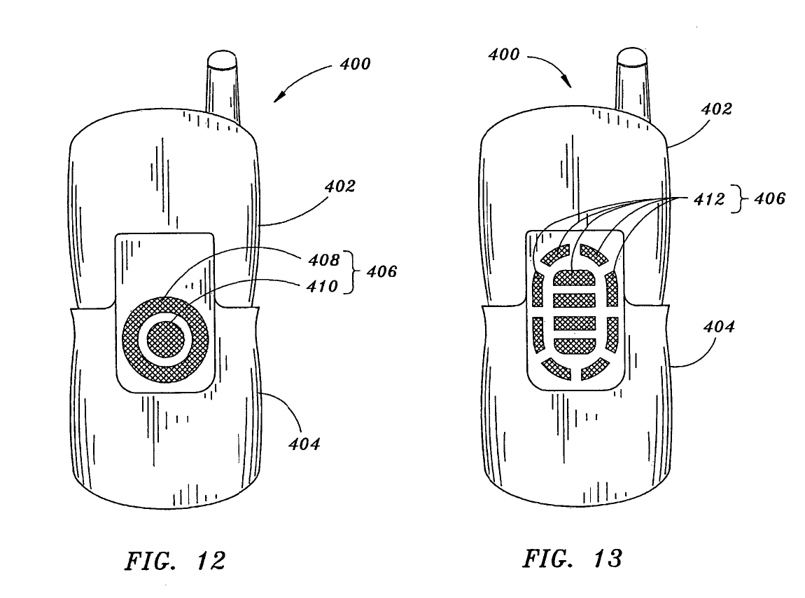

FIGS. 10 through 12 illustrate an exemplary mobile communication device 400, which comprises a mobile telephone 402 having a clip assembly 404 configured to attach the mobile telephone 402 to a belt or garment pocket or other item worn by a user of the mobile telephone. In a specific embodiment, the electrode assembly 406 of the mobile communication device 400 comprises electrodes 408 and 410 (FIG. 12) or 412 (FIG. 13) positioned on the belt clip of the mobile communication device 400 so that they are held in galvanic or capacitive contact with the skin of the user when the belt clip assembly 404 is attached to the belt. In exemplary embodiments, the clip assembly 404 may be detached from the mobile telephone 402 when not needed. Preferably, electrical interconnection is provided between the clip assembly 404 and the mobile telephone 402 for transmitting the electrical signal to the electrodes (i.e., electrodes 408 and 410 (FIG. 12) or electrodes 412 (FIG. 13)) of the electrode assembly 406.

In one embodiment, shown in FIG. 12, the electrode assembly 406 may include a first electrode 408 and a second electrode 410. In this embodiment, one electrode 408 or 410 may function as positive electrode, while the other electrode 410 or 408 functions as a negative electrode so that the electrical signal provided by the electrode assembly 406 is passed between the electrodes 408 and 410, through the body, to stimulate sensory nerves within the skin of the user. Alternatively, as shown in FIG. 13, the electrode assembly 406 may comprise three or more electrodes 412. In this embodiment, one or more of the electrodes 412 function as positive electrodes, while the remaining electrodes 412 function as negative electrodes so that the electrical signal provided by the electrode assembly 406 is passed through the body to stimulate sensory nerves within the skin at the waist of the user (or, alternatively, at the point where the mobile communication device 400 is clipped to the clothing of the user). Preferably, the number and position of electrodes 412 that are excited is controlled (e.g., by controller 108 shown in FIGS. 1A and 1B) to vary the form of the electrical stimulation communicated to the user. In this manner, the electrode assembly 406 may provide electrical stimulations having characteristics that may be distinguished by the user and may be associated by the user with the type of information received or provided by the communication device 400 (e.g., a telephone call, text message, low battery indication, or the like).

In the discussion of FIGS. 2 through 13, exemplary mobile communication devices 200, 300 and 400 have been described to illustrate possible implementations of the present invention. However, the use of electrical stimulation in accordance with the present invention is not limited to the specific mobile communication devices 200, 300 and 400 illustrated. Instead, it is contemplated that the present invention may be implemented in any mobile communication device (e.g., mobile telephones implemented as rings designed to be worn on the fingers of a user, in pagers, in wireless enabled palmtop computers, in cordless telephones, or the like). Accordingly, implementation in mobile communication devices other than those specifically shown and described herein would not depart from the scope and intent of the present invention.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A mobile communication device, comprising:
an electrical power source for generating an electrical signal; and
an electrode assembly coupled to the electrical power source for communicating the electrical signal to the body of a user of the mobile communication device,
wherein the electrical signal provides an electrical stimulation to the body of the user when communicated to the body by the electrode assembly for silently alerting the user that information has been received by the mobile communication device.

2. The mobile communication device as claimed in claim 1, further comprising a controller for controlling communication of the electrical signal to the body of the user.

3. The mobile communication device as claimed in claim 2, wherein the controller controls at least one of the voltage of the electrical signal, the current of the electrical signal, the amplitude of the electrical signal, the frequency of the electrical signal, the point on the body where the electrical signal is applied, and the form of the electrical signal.

4. The mobile communication device as claimed in claim 1, wherein the electrode assembly comprises at least a first electrode and a second electrode, the electrical signal being passed through the body between the first electrode and the second electrode.

5. The mobile communication device as claimed in claim 1, wherein the electrode assembly comprises at least a first electrode, a second electrode and a third electrode, the electrical signal being passed through the body of the user between at least two of the first electrode, the second electrode, and the third electrode for varying the form of the electrical signal to provide a distinguishing characteristic associated with the information received by the communication device.

6. The mobile communication device as claimed in claim 1, wherein the information received by the communication device comprises at least one of a telephone call, a text message, a voice message, and a page.

7. The mobile communication device as claimed in claim 1, wherein the electrode assembly comprises at least two electrodes galvanically coupled to the body of the user.

8. The mobile communication device as claimed in claim 1, wherein the electrode assembly comprises at least two electrodes capacitively coupled to the body of the user through a thin insulator.

9. The mobile communication device as claimed in claim 1, further comprising a housing for containing the electrical power source and a band assembly coupled to the housing for securing the housing to the user, wherein the electrode assembly comprises an electrode disposed in at least one of the housing and the band assembly.

10. The mobile communication device as claimed in claim 1, further comprising a housing for containing the electrical power source and a hanging assembly coupled to the housing for hanging the housing about the user, wherein the electrode assembly comprises an electrode disposed in at least one of the housing and the hanging assembly.

11. The mobile communication device as claimed in claim 1, further comprising a housing for containing the electrical power source and a clip assembly coupled to the housing for attaching the housing to an item worn by the user, wherein the electrode assembly comprises an electrode disposed in the clip assembly.

12. The mobile communication device as claimed in claim 1, wherein the electrical signal may further provide an electrical stimulation to the body of the user when communicated to the body by the electrode assembly for silently alerting the user that information is being provided by the mobile communication device.

13. A mobile communication device, comprising:
a housing;
a band assembly coupled to the housing for attaching the housing to the user;
an electrical power source contained within the housing for generating an electrical signal;
an electrode assembly coupled to the electrical power source for communicating the electrical signal to the body of a user of the mobile communication device;
a controller for controlling communication of the electrical signal to the body of the user, wherein the controller controls communication of the electrical signal to provide an electrical stimulation to the body of the user for silently alerting the user that information has been received by the mobile communication device.

14. The mobile communication device as claimed in claim 13, wherein the controller controls at least one of the voltage of the electrical signal, the current of the electrical signal, the amplitude of the electrical signal, the frequency of the electrical signal, the point on the body where the electrical signal is applied, and the form of the electrical signal.

15. The mobile communication device as claimed in claim 13, wherein the electrode assembly comprises at least a first electrode and a second electrode disposed on the housing adjacent to the body of the user, the electrical signal being passed through the body between the first electrode and the second electrode.

16. The mobile communication device as claimed in claim 13, wherein the, electrode assembly comprises at least a first electrode, a second electrode and a third electrode, the electrical signal being passed through the body of the user between at least two of the first electrode, the second electrode, and the third electrode for varying the form of the electrical signal to provide a distinguishing characteristic associated with the information received by the mobile communication device.

17. The mobile communication device as claimed in claim 13, wherein the information received by the mobile communication device comprises at least one of a telephone call, a text message, a voice message, and a page.

18. The mobile communication device as claimed in claim 13, wherein the electrode assembly comprises an electrode disposed in at least one of the housing and the band assembly.

19. A mobile communication device, comprising:
a housing;
a hanging assembly coupled to the housing for hanging the housing from a user of the mobile communication device;
an electrical power source contained within the housing for generating an electrical signal;
an electrode assembly coupled to the electrical power source for communicating the electrical signal to the body of the user of the mobile communication device;
a controller for controlling communication of the electrical signal to the body of the user,
wherein the controller controls communication of the electrical signal to provide an electrical stimulation to the body of the user for silently alerting the user that information has been received by the mobile communication device.

20. The mobile communication device as claimed in claim 19, wherein the controller controls at least one of the voltage of the electrical signal, the current of the electrical signal, the amplitude of the electrical signal, the frequency of the electrical signal, the point on the body where the electrical signal is applied, and the form of the electrical signal.

21. The mobile communication device as claimed in claim 19, wherein the electrode assembly comprises at least a first electrode and a second electrode disposed on the hanging assembly adjacent to the body of the user, the electrical signal being passed through the body between the first electrode and the second electrode.

22. The mobile communication device as claimed in claim 19, wherein the electrode assembly comprises at least a first electrode, a second electrode and a third electrode, the electrical signal being passed through the body of the user between at least two of the first electrode, the second electrode, and the third electrode for varying the form of the electrical signal to provide a distinguishing characteristic associated with the information received by the mobile communication device.

23. The mobile communication device as claimed in claim 19, wherein the information received by the mobile communication device comprises at least one of a telephone call, a text message, a voice message, and a page.

24. The mobile communication device as claimed in claim 19, wherein the electrode assembly comprises an electrode disposed in at least one of the housing and the hanging assembly.

25. A mobile telephone, comprising:
an electrical power source for generating an electrical signal; and
an electrode assembly coupled to the electrical power source for communicating the electrical signal to the body of a user of the mobile telephone;
a controller for controlling communication of the electrical signal to the body of the user, wherein the controller controls communication of the electrical signal to provide an electrical stimulation to the body of the user for silently alerting the user that information has been received by the mobile telephone.

26. The mobile telephone as claimed in claim 25, wherein the controller controls at least one of the voltage of the electrical signal, the current of the electrical signal, the amplitude of the electrical signal, the frequency of the electrical signal, the point on the body where the electrical signal is applied, and the form of the electrical signal.

27. The mobile telephone as claimed in claim 25, wherein the electrode assembly comprises at least a first electrode and a second electrode, the electrical signal being passed through the body between the first electrode and the second electrode.

28. The mobile telephone as claimed in claim 25, wherein the electrode assembly comprises at least a first electrode, a second electrode and a third electrode, the electrical signal being passed through the body of the user between at least two of the first electrode, the second electrode, and the third electrode for varying the form of the electrical signal to provide a distinguishing characteristic associated with the information received by the communication device.

29. The mobile telephone as claimed in claim 25, wherein the information received by the communication device comprises at least one of a telephone call, a text message, a voice message, and a page.

30. The mobile telephone as claimed in claim 25, wherein the electrode assembly comprises at least two electrodes galvanically coupled to the body of the user.

31. The mobile telephone as claimed in claim 25, wherein the electrode assembly comprises at least two electrodes capacitively coupled to the body of the user through a thin insulator.

32. The mobile telephone as claimed in claim 25, further comprising a housing for containing the electrical power source and controller; and a band assembly coupled to the housing for attaching the housing to the user, wherein the electrode assembly comprises an electrode disposed in at least one of the housing and the band assembly.

33. The mobile telephone as claimed in claim 25, further comprising a housing for containing the electrical power source and controller; and a hanging assembly coupled to the housing for hanging the housing from the user, wherein the electrode assembly comprises an electrode disposed in at least one of the housing and the hanging assembly.

34. The communication device as claimed in claim 25, further comprising a housing for containing the electrical power source and a clip assembly coupled to the housing for attaching the housing to an item worn by the user, wherein the electrode assembly comprises an electrode disposed on the clip assembly.

35. A mobile communication device, comprising:
means for providing an electrical signal; and
means for communicating the electrical signal to the body of a user of the mobile communication device,
wherein the electrical signal provides an electrical stimulation to the body of the user when communicated to the body for silently alerting the user that information has been received by the mobile communication device.

36. The mobile communication device as claimed in claim 35, wherein the electrical signal may further provide an electrical stimulation to the body of the user when communicated to the body by the electrode assembly for silently alerting the user that information is being provided by the mobile communication device.
